(19) United States
(12) Patent Application Publication
(10) Pub. No.: US 2026/0150859 A1
(43) Pub. Date: Jun. 4, 2026

(54) Edible Organic Baby Teether and Method of Manufacture Thereof

(71) Applicants: Christin Braxton, Wake Forest, NC (US); Sharon Lowery, Wake Forest, NC (US)

(72) Inventors: Christin Braxton, Wake Forest, NC (US); Sharon Lowery, Wake Forest, NC (US)

(21) Appl. No.: 19/406,713

(22) Filed: Dec. 2, 2025

Related U.S. Application Data
(60) Provisional application No. 63/727,728, filed on Dec. 4, 2024.

(51) Int. Cl. A23G 9/42; A23G 9/08; A23G 9/26; A23G 9/32; A23G 9/34; A23G 9/36; A23G 9/48; A23G 9/50; A23L 33/00; A61J 17/00; A61J 17/02

(52) U.S. Cl. CPC A23G 9/42; A23G 9/083; A23G 9/26; A23G 9/327; A23G 9/34; A23G 9/363; A23G 9/366; A23G 9/48; A23G 9/503; A23G 9/506; A23L 33/40; A61J 17/02; A61J 17/111

(57) ABSTRACT

An edible organic baby teether is disclosed, comprising a frozen therapeutic confectionery formulated from organic nut butter and natural sweeteners, shaped to be safely chewed and consumed by infants for relief of teething discomfort. The invention provides a dual-function teething aid that offers both cooling therapy and nutritional benefit, eliminating the risks associated with synthetic or non-edible teethers. In the preferred embodiment, the composition includes almond, peanut, or cashew butter blended with organic honey, agave nectar, or maple syrup, molded into a popsicle form with an integrated edible or biodegradable handle for infant grasping. When frozen, the product delivers a soothing, gum-numbing effect, and as it softens, it may be safely ingested, providing essential nutrients such as proteins and healthy fats. A method of manufacture is also disclosed, including steps of mixing, molding, freezing, and packaging the organic composition to achieve a soft-freeze texture optimized for infant safety and enjoyment.

### BACKGROUND OF THE INVENTION

### 1. Field of the Invention

The present invention relates generally to infant care, nutritional food products, and oral soothing devices and, more particularly, to an edible organic teething aid for infants and young children in a form of a frozen, consumable teether made from natural and organic ingredients.

### 2. Description of the Related Art

Teething is a natural developmental process that all infants experience as their teeth begin to emerge through the gums. This process often causes considerable discomfort, pain, and irritability in infants and toddlers. Parents and caregivers have long sought effective and safe methods to ease this pain, commonly resorting to teething rings, cold washcloths, or over-the-counter gels. While these traditional methods may provide temporary relief, they often lack nutritional value and may pose safety risks, particularly when made from synthetic materials or when used incorrectly.

Traditional teething devices, such as liquid-filled or gel-based teethers, are designed to be cooled or frozen to provide temporary numbing relief. Examples include the teething devices described in U.S. Patent Application Publication No. 2011/0118782 A1 (“Infant Teething Device”), which discloses a liquid-fillable device capable of thermal treatment to the gums. While such devices achieve cooling relief, they are typically made from synthetic plastics, silicones, or gels, which may degrade, rupture, or pose choking hazards when bitten by infants. Additionally, parents increasingly express concern over potential exposure to chemicals such as BPA (bisphenol-A), phthalates, and other leachable compounds. These synthetic devices also lack nutritional value and must be sterilized frequently to prevent bacterial growth, making them inconvenient for everyday use.

Some innovations have explored the use of frozen confectionery for therapeutic or functional purposes. For instance, U.S. Patent Application Publication No. 2012/0282317 A1 (“Medicated Popsicle System”) describes a popsicle mold and formulation for delivering active ingredients or medications in a frozen treat. Although this prior art demonstrates the concept of combining therapy with frozen confectionery, it is directed primarily at drug delivery in frozen desserts, rather than an edible teething relief composition for infants. The formulations disclosed often contain artificial stabilizers or non-organic ingredients unsuitable for infant consumption. Thus, while they provide a precedent for medicated frozen compositions, they do not address the specific safety and nutritional concerns unique to teething infants.

More recently, U.S. Patent Application Publication No. 2022/0218570 A1 (“Teether”) discloses a food-retaining teether that holds pieces of solid or frozen food inside a perforated container or mesh structure, allowing the infant to gum the food without direct access. While this design introduces the concept of combining food and teething relief, it is a device for retaining edible content, not a self-contained, fully edible product. The structure remains non-consumable, and the composition of the food contained is not controlled by the invention. Therefore, this prior art fails to provide a fully organic, edible solution where the entire teether, including the soothing component, is food-grade and safe for ingestion.

Another relevant disclosure, U.S. Patent Application Publication No. 2010/0266730 A1 (“Edible Ice Cream Stick”), teaches the use of edible support members or sticks made from candy or cereal materials for frozen desserts. This concept establishes that the support or handle of a frozen treat can be consumable. However, the focus of that invention is on novelty or confectionery enjoyment, not therapeutic or teething-related benefits. The formulation, size, and safety considerations are tailored to general consumers, not infants. Consequently, this art is distinguishable from the present invention, which provides a therapeutic purpose and baby-safe composition.

Manufacturing references such as EP 0500940 A1 (“Combination Popsicle, Method of Making”) describe techniques for forming layered or filled frozen confections. While relevant to the process of molding and freezing edible materials, these methods are primarily aimed at creating multi-flavor or dual-texture desserts, rather than therapeutic or nutritional aids for teething infants. The prior art does not consider the physiological need for a specific hardness or temperature profile suitable for infant gums.

In addition to formal patent literature, several non-patent references and commercial sources disclose homemade or retail products aimed at natural teething relief. For example, baby-food blogs and websites such as YummyToddlerFood and Once Upon a Farm provide recipes for “baby popsicles” made by freezing fruit purees, yogurt, or nut butter mixtures for soothing teething discomfort. These remedies are typically improvised and lack standardization, consistency, and safety validation for commercial sales. Similarly, fillable silicone teethers, available through major online retailers, allow parents to freeze breast milk or pureed foods inside mesh or silicone housings. Although these offer cold relief, they require non-edible components and are not standardized in composition, raising hygiene and safety concerns. None of these sources disclose a commercially standardized, fully edible organic teether composition designed with specific dimensions, texture, and formulation optimized for infant handling and consumption.

Recent studies, such as “Soothing Effect of an Edible Teether: A Pilot Study in Children” (PubMed Central, 2021), have demonstrated that edible teethers can effectively reduce crying and restlessness during teething. However, such studies typically evaluate general food-based teethers like biscuits or wafers and do not involve frozen formulations or nut-based nutritional compositions. These findings reinforce the feasibility of edible teethers as a category but also highlight the absence of a structured, standardized product that delivers both cooling therapy and nutritional benefit in a safe, organic format.

Despite the variety of teething aids available, a significant gap remains in providing an organic, food-grade, and entirely edible product that offers the therapeutic benefits of cooling along with the nutritional value of natural ingredients. Existing devices either rely on synthetic materials, require parental intervention, or lack appeal to infants. Homemade remedies, while natural, lack standardization, shelf stability, and controlled composition.

There is therefore a strong and unmet need for a frozen teething confectionery that is safe for direct infant consumption, convenient for parents, and capable of soothing teething pain through both temperature and texture, while delivering nutritional support through organic ingredients.

### SUMMARY OF THE INVENTION

It is an object of the present invention to overcomes the limitations of prior art by introducing a therapeutic frozen confectionery teether that is fully edible, organically formulated, and specially dimensioned for infant handling.

It is a feature of the present invention, unlike device-based teethers or medicated popsicles, to utilize natural nut butters and sweeteners to produce a wholesome, baby-safe frozen composition that retains its structure when frozen yet softens slightly during use to prevent gum injury.

Further, the inclusion of an integrated handle (either edible or food-safe) allows infants to self-soothe safely and independently.

The present invention provides an edible organic teething aid for infants and toddlers, designed in the form of a frozen therapeutic confectionery or popsicle that delivers both soothing relief for teething discomfort and nutritional benefits through its organic, food-grade composition. Unlike traditional teething devices composed of synthetic materials or non-edible components, the present invention is entirely consumable, formulated from safe, organic ingredients, and shaped for easy handling by infants. When used frozen or chilled, the product produces a gentle numbing effect on the gums, easing the pain caused by erupting teeth, while simultaneously offering a pleasant taste and nutritional value.

In its preferred embodiment, the invention comprises a mixture of organic nut butters including, but not limited to, almond butter, peanut butter, and cashew butter combined with natural sweeteners such as organic honey, maple syrup, or agave nectar. These ingredients are selected for their smooth texture, high nutritional content, and safe digestibility for young children. The ratio of nut butter to sweetener is optimized to achieve a balance between firmness when frozen and softness when chewed, ensuring that the teether remain intact while being safe on tender gums. Optionally, mild organic flavorings (e.g., banana, vanilla, or oat milk) may be incorporated to enhance palatability without compromising safety or nutritional value.

The frozen confectionery is formed in the shape of a miniature popsicle, with an overall length of approximately 3.5 to 4.0 inches and a width suitable for an infant's grip. A handle or stick is embedded in the base of the confection, providing a secure holding point for small hands. In one embodiment, the handle is made from food-safe biodegradable material, such as compressed paper or bamboo; in another embodiment, it may be edible, composed of a firmer layer of the same or compatible organic material (e.g., oat flour and honey composite). This handle allows independent use by the child without direct parental assistance, while preventing choking hazards. The shape may vary, being rounded, cylindrical, or flattened or other configuration to optimize comfort and safety in the infant's mouth.

The method of manufacturing the edible organic baby teether comprises a sequence of hygienic and food-safe processing steps designed to ensure consistency, safety, and preservation of the organic integrity of the ingredients. In the preferred embodiment, the process begins with a mixing step in which a measured quantity of an organic nut butter selected from almond, peanut, cashew, or similar varieties combined with a natural sweetener, such as organic honey, agave nectar, or maple syrup, to form a smooth, homogeneous base composition. The mixing may be performed manually or using a food-grade mixer at low speed to prevent aeration and to maintain a uniform texture. Once the composition attains the desired consistency, it is transferred to a molding step, wherein the mixture is poured into sterile, food-grade molds shaped to form a miniature popsicle or teether configuration. During this stage, a handle element is introduced into each mold cavity, preferably centered and partially submerged in the mixture, so as to become securely embedded upon freezing. The handle may be non-edible (such as bamboo or compostable paper) or edible (composed of oat flour, cereal, or compatible organic binder materials).

After the molds are filled and handles are positioned, the assembly proceeds to the freezing step, where the molded composition is chilled at temperatures ranging between −10° C. and −20° C. until the mixture achieves structural solidity while maintaining a soft-bite consistency suitable for infant use. Controlled freezing prevents crystallization and ensures that the final product is smooth and uniform, without sharp edges or brittle surfaces. Following complete freezing, each unit is demolded under sanitary conditions and may optionally undergo a wrapping and packaging step, where individual teethers are enclosed in sterile, moisture-resistant wrapping such as biodegradable film or compostable foil or other functionally equivalent wrapping to preserve hygiene and prevent freezer contamination. Multiple wrapped units can then be grouped into larger retail packages designed for safe, long-term storage under standard frozen conditions.

Quality control procedures are implemented at each stage to verify ingredient ratios, texture, and freezing consistency. Optional variations in the method may include the incorporation of fruit purées, oat milk, or plant-based additives during the mixing phase, as well as multi-layer molding for aesthetic or textural differentiation. The described process allows for scalable production using conventional frozen confectionery equipment, making the invention suitable for both small-batch artisanal preparation and industrial mass production. The simplicity of the process, coupled with the exclusive use of organic food-grade ingredients, ensures a cost-effective and sustainable manufacturing method that produces a uniform, safe, and therapeutically effective edible teether optimized for infant handling and consumption.

When the frozen teether is applied to the mouth, the cold temperature provides natural numbing relief, temporarily reducing inflammation and pain in the gums. As the popsicle softens, the infant can safely chew and ingest the mixture, obtaining essential nutrients such as healthy fats, protein, and natural sugars from the nut butter and sweeteners. This dual function—therapeutic cooling and nutritional enrichment—makes the product particularly beneficial during early developmental stages when both comfort and nourishment are crucial.

For commercial use, multiple units of the edible teether may be packaged together in child-safe, recyclable containers. Each unit can be individually wrapped to maintain hygiene and prevent cross-contamination. The frozen confectionery is designed to retain texture and flavor when stored under standard freezing conditions (−18° C. or below) for several months. Batch labeling may include expiration dates and ingredient disclosure to comply with food safety regulations. The simple composition and absence of synthetic stabilizers facilitate cost-effective mass production and distribution using conventional frozen dessert equipment.

It is an advantage of the present invention to provide a teething remedy that combines therapeutic relief with nutritional benefits.

It is another advantage of the present invention to provide a teething aid made entirely from organic, natural ingredients that are safe for consumption.

It is another advantage of the present invention to provide a frozen confectionery that maintains structural integrity while being soft enough for infant consumption.

It is another advantage of the present invention to offer a teething solution with a pleasing taste that encourages continued use by infants and young children.

It is another advantage of the present invention to provide a teething aid that can be easily held and manipulated by small hands.

It is another advantage of the present invention to deliver a soothing cooling effect without the use of artificial materials or non-food substances.

It is another advantage of the present invention to provide a teething remedy that eliminates concerns about exposure to synthetic materials, additives, or potential allergens found in traditional teething devices.

It is another advantage of the present invention to offer a teething solution that can be conveniently stored, with multiple units packaged together for extended use.

It is another advantage of the present invention to provide a cost-effective solution using readily available organic ingredients and simple manufacturing processes.

Further features of the invention will become apparent in the course of the following description.

### BRIEF DESCRIPTION OF DRAWINGS

The advantages and features of the present invention will become better understood with reference to the following more detailed description and claims taken in conjunction with the accompanying drawings, in which like elements are identified with like symbols, and in which:

FIG. 1 illustrates a perspective view of the edible organic baby teether, shown in the form of a frozen popsicle comprising the confectionery body and integrated handle;

FIG. 2 illustrates an exemplary environmental view depicting a toddler or infant using the edible teether, demonstrating how the product is comfortably grasped and consumed to provide teething relief; and

FIG. 3 illustrates a process flow diagram showing the method of manufacturing the edible organic baby teether, including the sequential steps of mixing, molding, freezing, and packaging the organic composition.

### DETAILED DESCRIPTION OF THE INVENTION

The best mode for carrying out the invention is presented in terms of its preferred embodiment, herein depicted within the Figures. It should be understood that the legal scope of the description is defined by the words of the claims set forth at the end of this patent and that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

The best mode for carrying out the invention is presented in terms of its preferred embodiment, herein depicted within the Figures.

### 1. Detailed Description of the Figures

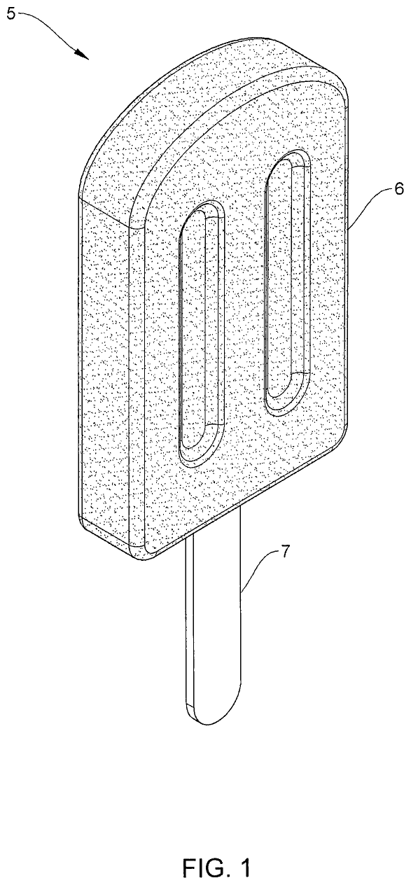

With reference now to the drawings, and in particular from FIG. 1 to FIG. 3 thereof, a Therapeutic Frozen Confectionary for Infant Teething Relief embodying the principles and concepts of the present invention is described.

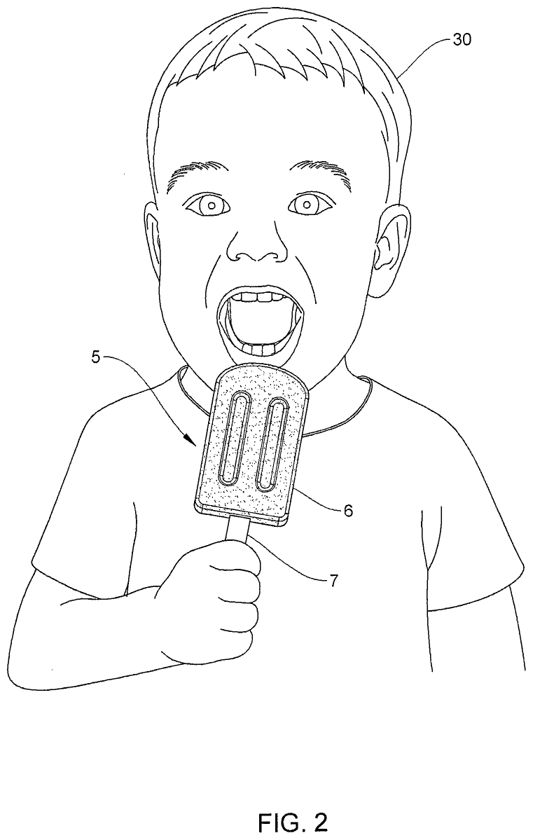

Referring now to FIG. 1, the present invention comprises a frozen therapeutic confectionery (5) configured to function as an edible teething aid for infants and toddlers experiencing gum discomfort during tooth eruption. The frozen confectionery (5) includes a confectionery form (6) and a handle (7) extending therefrom. The confectionery form (6) is composed entirely of food-grade, organic ingredients formulated to remain structurally stable when frozen yet soft enough to be safely chewed. The handle (7) provides an easy gripping surface for a user (30), such as an infant or toddler as shown in FIG. 2, allowing independent handling and oral application without direct caregiver manipulation.

The edible composition of the confectionery form (6) consists primarily of two base components: a first ingredient (11) comprising one or more organic nut butters, and a second ingredient (12) comprising one or more natural sweeteners. The nut butter component may include almond butter, peanut butter, or cashew butter, although alternative nut-or seed-derived butters such as sunflower, pumpkin seed, or oat butter may also be employed for allergen-free variants. The sweetener component may be selected from organic honey, agave nectar, maple syrup, or similar plant-based syrups. These components are combined in proportion to achieve an ideal balance between taste, nutritional value, and textural consistency. The preferred ratio ranges from about 2:1 to 4:1 by weight of nut butter to sweetener.

Optional ingredients may be incorporated to enhance flavor or nutritional properties without compromising safety. Examples include small quantities of organic fruit purées (banana, apple, or blueberry), oat or almond milk for creaminess, and natural flavor extracts such as vanilla. All ingredients are certified organic and free from artificial preservatives, coloring agents, stabilizers, or emulsifiers. The resulting mixture is smooth, homogeneous, and palatable for infants aged six months and above.

The confectionery form (6) is shaped using a mold designed for safe infant use. In the preferred embodiment, the frozen product has an overall length of approximately 3.5 to 4 inches (8.9-10.2 cm), with the handle occupying about one-third of the total length. The upper portion, intended for oral contact, is rounded and tapered to prevent injury and to fit comfortably within the infant's mouth. The surface may be smooth or include shallow texturing to enhance tactile stimulation of the gums. The handle (7) may be fabricated from food-safe biodegradable material such as compressed paper, bamboo, or edible cereal-based composite, and is securely anchored into the confectionery mass during molding.

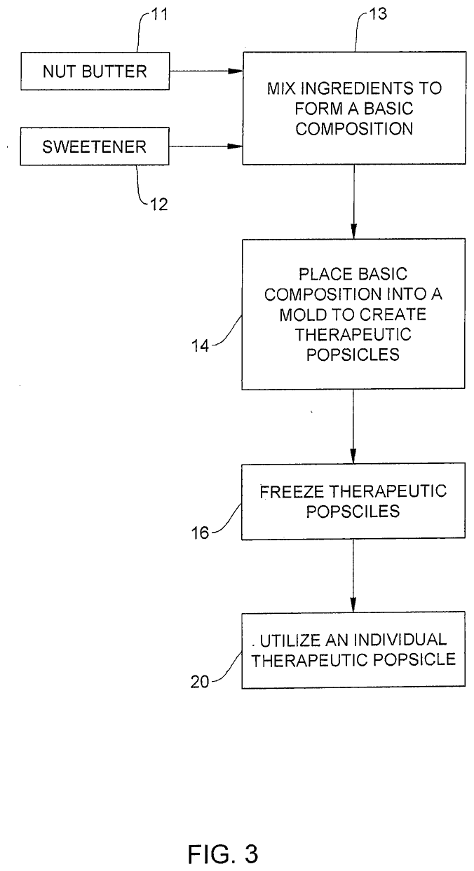

The manufacturing process is illustrated in FIG. 3 and comprises four principal steps: mixing (13), molding (14), freezing (16), and use or consumption (20).

Mixing Step (13): The first ingredient (11) and second ingredient (12) are measured and combined in a mixing vessel under sanitary conditions. The ingredients are blended using a low-speed mechanical mixer or planetary stirrer until a uniform base composition is achieved. The temperature is maintained below 40° C. to preserve nutrient quality and prevent oil separation from the nut butter.

Molding Step (14): The base composition is dispensed into individual cavities of a sterile, food-grade mold designed to form the desired teether shape. A handle (7) is inserted into each mold so that its lower end becomes embedded in the mixture. The volume of each mold cavity may vary from 20 ml to 40 ml depending on the intended age group of the user. The molds may be silicone, stainless steel, or biodegradable polymer suitable for repeated freezing cycles.

Freezing Step (16): The filled molds are transferred to a blast freezer or standard commercial freezer maintained between −10° C. and −20° C. Freezing continues until the composition attains a semi-solid yet stable consistency, typically within 4 to 6 hours. The process ensures that the mixture retains a fine, uniform crystalline structure, preventing brittleness and ensuring a gentle mouthfeel when consumed.

Use Step (20): After freezing, the finished teether popsicles are demolded and packaged for storage or immediate use. When administered, the frozen temperature provides a natural numbing effect, reducing gum inflammation and pain. As the product softens in the mouth, the infant can safely ingest the mixture, deriving nutritional benefit while continuing to soothe the affected area.

After demolding, each frozen unit is individually wrapped in a sterile, moisture-resistant biodegradable film to maintain hygiene and prevent freezer burn. Multiple units can be packaged together in recyclable cartons or pouches. The product remains stable for up to six months when stored below −18° C. Each package bears ingredient labeling, nutritional information, and usage instructions, ensuring compliance with infant-food safety standards.

When applied to the gums, the frozen confectionery delivers therapeutic benefits through cooling, gentle pressure, and palatable stimulation. The cold temperature produces mild vasoconstriction that alleviates swelling and numbs the gums, while the soft yet resilient texture allows safe gnawing without risk of gum injury. As the confection gradually softens, it provides essential nutrients, including protein, healthy fats, and natural sugars, promoting satiety and comfort. The pleasant flavor profile encourages infants to continue use, enabling sustained soothing action.

In alternative embodiments, the edible organic baby teether may be formulated, shaped, or enhanced in various ways to accommodate different dietary needs, flavor preferences, and developmental stages of infants. For instance, the nut butter component may be replaced with allergen-free alternatives such as sunflower seed butter, pumpkin seed butter, or oat-based spreads to create a nut-free variant suitable for sensitive consumers. In another embodiment, fruit or vegetable purées such as banana, mango, sweet potato, or spinach may be incorporated to add natural sweetness, vitamins, and color, while maintaining the frozen confection's structural stability. The invention may also include multi-layered or filled configurations, where a firm outer shell encloses a softer, nutrient-dense core, providing a varied sensory experience and improved durability during use. Additionally, probiotic cultures, plant-based calcium, or vitamin supplements may be introduced into the mixture to enhance digestive and developmental benefits. Flavor variations using mild organic ingredients such as vanilla, cinnamon, or coconut milk can also be offered to appeal to different age groups. Structurally, the teether may be formed in multiple shapes such as rings, bars, or animal figures, each designed to improve grip or stimulate different areas of the gums. The handle portion may be edible, dissolvable, or biodegradable, depending on the target market and packaging requirements. Furthermore, alternative freezing methods, such as partial freezing or flash freezing, may be used to control texture and cooling intensity. These optional embodiments collectively broaden the functional, nutritional, and sensory scope of the invention, allowing it to be customized for diverse infant needs while maintaining its core therapeutic and organic properties.

The described process is compatible with existing frozen-dessert production lines and requires no specialized or high-temperature equipment, thereby minimizing energy consumption and manufacturing cost. Because the ingredients are plant-based and widely available, the method allows for scalable, sustainable production suitable for both small-scale home preparation and industrial commercialization. The simple, four-step manufacturing sequence ensures reproducibility, product safety, and consistent quality control.

### 2. Operation of the Preferred Embodiment

In operation, the caregiver removes the frozen teether from its packaging and presents it directly to the infant. The ergonomic handle (7) enables self-grasping by small hands. As the confection contacts the gums, the infant receives immediate relief from discomfort while consuming a nutritionally beneficial treat. The product can be offered multiple times per day during teething episodes, under parental supervision. Because the entire teether is edible or composed of biodegradable components, no wasteful synthetic parts remain after use.

The edible organic baby teether described herein distinguishes itself from prior art through its complete edibility, organic formulation, and dual therapeutic-nutritional function. Unlike conventional gel-filled or silicone devices, it poses no choking or toxicity risk. Unlike homemade frozen mixtures, it provides standardized texture, controlled hardness, and shelf stability. The invention's balance of safety, functionality, and sustainability renders it a unique and practical solution for infant teething care.

The foregoing descriptions of specific embodiments of the present invention are presented for purposes of illustration and description. The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way. Any unintended embracement of such subject matter is hereby disclaimed. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this Patent Application.

1. An edible organic baby teether comprising:
a frozen confectionery body formed from a mixture of organic nut butter and natural sweetener; and
a handle portion embedded in said frozen confectionery body to facilitate gripping by an infant;
wherein the frozen confectionery body is dimensioned and configured to be safely chewed and ingested by an infant or toddler for teething relief.

2. The edible organic baby teether of claim 1, wherein said nut butter comprises one or more of: almond butter, peanut butter, cashew butter, sunflower seed butter, pumpkin seed butter, or oat butter.

3. The edible organic baby teether of claim 1, wherein said natural sweetener comprises one or more of: organic honey, agave nectar, maple syrup, or plant-derived syrup.

4. The edible organic baby teether of claim 1, further comprising one or more organic additives selected from the group consisting of: fruit purée, vegetable purée, plant-based milk, or natural flavoring.

5. The edible organic baby teether of claim 1, wherein said frozen confectionery body is formed to have a soft-freeze consistency that provides cooling relief without risk of gum injury.

6. The edible organic baby teether of claim 1, wherein said frozen confectionery body has a length of approximately 3.5 to 4 inches and a cross-sectional width suitable for gripping by an infant's hand.

7. The edible organic baby teether of claim 1, wherein said handle portion is selected from the group consisting of:
an edible handle formed from organic cereal, oat flour, or compressed fruit material; and
a biodegradable non-edible handle formed from bamboo, paper, or compostable fiber.

8. The edible organic baby teether of claim 1, wherein said frozen confectionery body is configured to provide therapeutic gum relief through cooling when frozen and nutritional benefits when consumed.

9. The edible organic baby teether of claim 1, wherein said mixture further comprises probiotic cultures, vitamins, or minerals to enhance infant nutrition and digestion.

10. The edible organic baby teether of claim 1, wherein said frozen confectionery body is produced by mixing organic ingredients under food-safe conditions, molding said mixture to a defined shape, and freezing until said body reaches a desired firmness.

11. The edible organic baby teether of claim 1, wherein said frozen confectionery body comprises multiple layers including an outer frozen shell and a softer inner core.

12. The edible organic baby teether of claim 1, wherein said confectionery body is individually wrapped and packaged in sterile, biodegradable wrapping for hygienic storage.

13. A method of manufacturing an edible organic baby teether, comprising the steps of:
mixing an organic nut butter and a natural sweetener to form a homogeneous composition;
dispensing said composition into a mold configured to form a teether shape;
inserting a handle portion into said mold such that the handle is partially embedded in said composition; and
freezing said mold until said composition attains a solid, chewable consistency suitable for teething relief.

14. The method of claim 13, further comprising wrapping and packaging each frozen teether in sterile, biodegradable film for refrigerated or frozen storage.

15. The method of claim 13, wherein said freezing step is performed at a temperature between −10° C. and −20° C. to achieve a controlled, soft-freeze texture.

16. The method of claim 13, wherein said mixing step further includes adding fruit purées, plant-based milk, or natural flavoring to enhance nutritional and sensory properties.

17. The method of claim 13, wherein said handle portion is edible and composed of organic cereal material or oat flour composite.

18. The method of claim 13, wherein said mixture is allergen-free and uses seed-based butters as substitutes for nut-derived butters.
